(19) United States
(12) Patent Application Publication
(10) Pub. No.: US 2004/0199443 A1
(43) Pub. Date: Oct. 7, 2004

(54) Method for standardizing reporting of issues, assumptions, and risks for a risk review board

(76) Inventors: Ian D. Gaston, Telford (GB); Phil Wolstenholme, Telford (GB)

Correspondence Address: STEPHEN R. LOE, THE LAW OFFICE OF STEPHEN R. LOE, P.O. BOX 649, FRISCOE, TX, 75034, US

(21) Appl. No.: 10/691,261

(22) Filed: Oct. 22, 2003

Related U.S. Application Data
(60) Provisional application No. 60/460,073, filed on Apr. 3, 2003.

(51) Int. Cl. G06F 17/60

(52) U.S. Cl. 705/35

(57) ABSTRACT

A method, system, and computer program product for standardizing reporting of issues, assumptions, and risks for a risk review board is provided. In one embodiment, a risk management tool presents a user with a form for entering information about a risk management unit, such as, for example, a risk, assumption, issue, or risk plan. The risk management tool then receives information about the risk management unit from the user through the form. The form provides the user with entry areas for every element needed to properly adhere to a risk management scheme for the particular risk management unit. Furthermore, the user is hindered or prevented from exiting the form prior to supplying all information necessary for adherence to the risk management scheme. Thus, the risk management tool increases the likelihood that risk managers adhere to a risk management scheme, thus minimizing the occurrence of identified risks.

### PRIORITY

This application claims the benefit of the filing date of corresponding U.S. Provisional Patent Application Serial No. 60/460,073, entitled “Method for Standardizing Reporting of Issues, Assumptions and Risks for a Risk Review Board”, filed Apr. 3, 2003, the contents of which are hereby incorporated herein for all purposes.

### BACKGROUND OF THE INVENTION

1. Technical Field

The present invention relates generally to computer software and, more particularly, to business methods, and, still more particularly, to methods for managing risks for an enterprise.

2. Description of Related Art

Risk can be defined as the possibility as suffering loss. In business, loss is typically measured in monetary terms, but the causes of monetary loss are many and related to many different risks. For example, in a development project, the loss describes the impact to the project which could be in the form of diminished quality of the end product, increased costs, delayed completion, or failure. Therefore, risk is something that businesses would prefer to avoid. However, risk and opportunity go hand in hand and in order to achieve profits, it is necessary to take risks. For example, many development projects strive to advance current capabilities and achieve something that hasn't been done before. Thus, the opportunity for advancement cannot be achieved without taking risk

However, risks can be minimized by proper attention to risk management, i.e., the proper balancing of the possible negative consequences of risk against the potential benefits of its associated opportunity. Many risk management schemes have been developed to aid managers in this process. However, one drawback to current schemes is that often the risk manager fails to adhere to all aspects of a risk management scheme, thus increasing the risk to the business without increasing the possible benefits to the business. Therefore, it would be desirable to have a computer program product, method, and system that increases the probability that a risk manager will adhere to all aspects of a risk management scheme.

### SUMMARY OF THE INVENTION

The present invention provides a method, system, and computer program product for standardizing reporting of issues, assumptions, and risks for a risk review board. In one embodiment, a risk management tool presents a user with a form for entering information about a risk management unit, such as, for example, a risk, assumption, issue, or risk plan. The risk management tool then receives information about the risk management unit from the user through the form. The form provides the user with entry areas for every element needed to properly adhere to a risk management scheme for the particular risk management unit. Furthermore, the user is hindered or prevented from exiting the form prior to supplying all information necessary for adherence to the risk management scheme. Thus, the risk management tool increases the likelihood that risk managers adhere to a risk management scheme, thus minimizing the occurrence of identified risks.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2 depicts a block diagram of a data processing system which may be implemented as a server in accordance with the present invention;

FIG. 3 depicts a block diagram of a data processing system in which the present invention may be implemented;

FIG. 4 depicts a process flow and program function diagram in accordance with one embodiment of the present invention;

FIG. 5 depicts an exemplary screen presented to a user upon opening the Risk Management Tool in accordance with one embodiment of the present invention;

FIG. 6 depicts an exemplary screen for entering information for a new issue in accordance with one embodiment of the present invention;

FIG. 7 depicts exemplary windows displayed when saving an issue in accordance with one embodiment of the present invention;

FIGS. 8A and 8B depict windows associated with entering and updating assumption records into the Risk Management Tool in accordance with one embodiment of the present invention;

FIGS. 9A-9C depict windows associated with entering and updating risk records into the Risk Management Tool from the Assumption screen in accordance with one embodiment of the present invention;

FIGS. 10A-10C depict various screen shots illustrating development of risk plans utilizing the Risk Management Tool of the present invention;

FIG. 11 depicts a screen related to configuring and displaying reports in accordance with one embodiment of the present invention;

FIGS. 12A-12B depict screens related to browsers include in the Risk Management Tool in accordance with one embodiment of the present invention; and

FIG. 13 depicts an exemplary screen illustrating adding keywords to the Risk register in accordance with one embodiment of the present invention.

### DETAILED DESCRIPTION OF THE PREFERRED EMBODIMENT

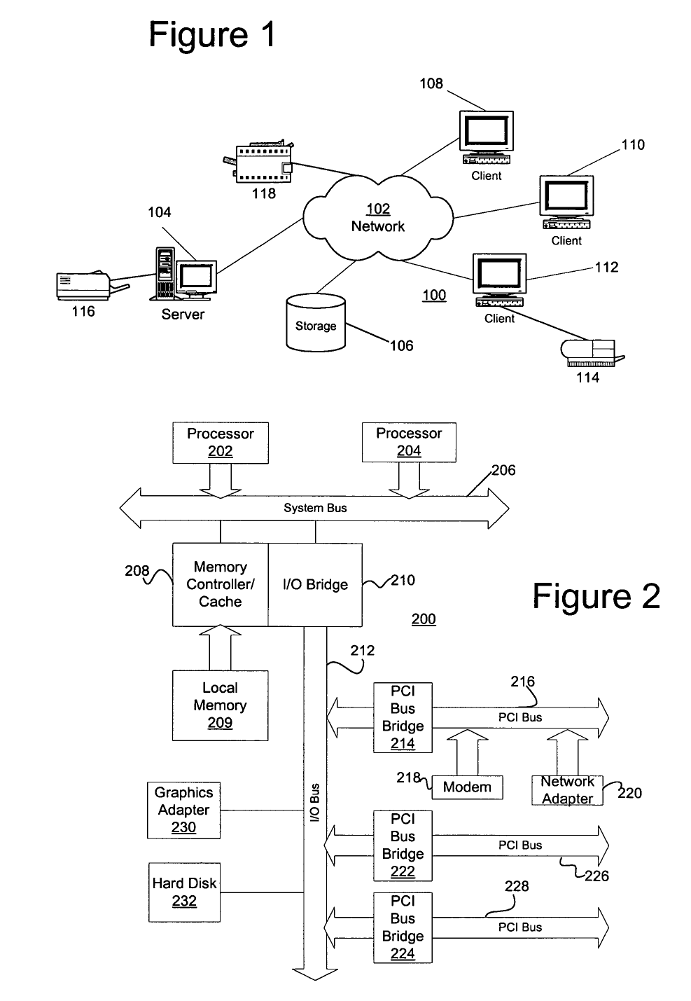

With reference now to the figures, and in particular with reference to FIG. 1, a pictorial representation of a distributed data processing system is depicted in which the present invention for prodding a risk manager to adhere to a risk management scheme may be implemented.

Distributed data processing system 100 is a network of computers in which the present invention may be implemented. Distributed data processing system 100 contains network 102, which is the medium used to provide communications links between various devices and computers connected within distributed data processing system 100. Network 102 may include permanent connections, such as wire or fiber optic cables, or temporary connections made through telephone connections.

In the depicted example, server 104 is connected to network 102, along with storage unit 106. In addition, clients 108, 110 and 112 are also connected to network 102. These clients, 108, 110 and 112, may be, for example, personal computers or network computers. For purposes of this application, a network computer is any computer coupled to a network that receives a program or other application from another computer coupled to the network. In the depicted example, server 104 provides data, such as boot files, operating system images and applications, to clients 108-112. Clients 108, 110 and 112 are clients to server 104. Distributed data processing system 110 may include additional servers, clients, and other devices not shown. Distributed data processing system 100 may also include printers. A client, such as client 110, may print directly to printer 114. Clients such as client 108 and client 112 do not have directly attached printers. These clients may print to printer 116, which is attached to server 104, or to printer 118, which is a network printer that does not require connection to a computer for printing documents. Client 110, alternatively, may print to printer 116 or printer 118, depending on the printer type and the document requirements.

In the depicted example, distributed data processing system 100 is the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, distributed data processing system 100 also may be implemented as a number of different types of networks such as, for example, an intranet or a local area network.

A person or persons responsible for enforcing risk management schemes on an organization enters appropriate risk data into the system, as will be discussed in great detail below, through any one of clients 108-112. This data is gathered by the persons responsible for enforcing risk management schemes through interviewing managers and others responsible for various areas of an enterprise. Managers or other members in any particular area of the organization are not able to edit the data, but are able to view data through a client, such as any of clients 108-112. Thus, for example, in a large organization in which many people work on a project unknown to others in a project, risks identified by one area are provided to people in other areas within the enterprise and these people may have expertise as to how to address this identified risk that the people in the other area did not have. However, in previous systems, the people with expertise as to how to address the risk may not even know of the risk.

FIG. 1 is intended as an example and not as an architectural limitation for the processes of the present invention.

Referring to FIG. 2, a block diagram of a data processing system which may be implemented as a server, such as server 104 in FIG. 1, is depicted in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

Data processing system 200 may be implemented as, for example, an AlphaServer GS1280 running a UNIX® operating system. AlphaServer GS1280 is a product of Hewlett-Packard Company of Palo Alto, Calif. “AlphaServer” is a trademark of Hewlett-Packard Company. “UNIX” is a registered trademark of The Open Group in the United States and other countries

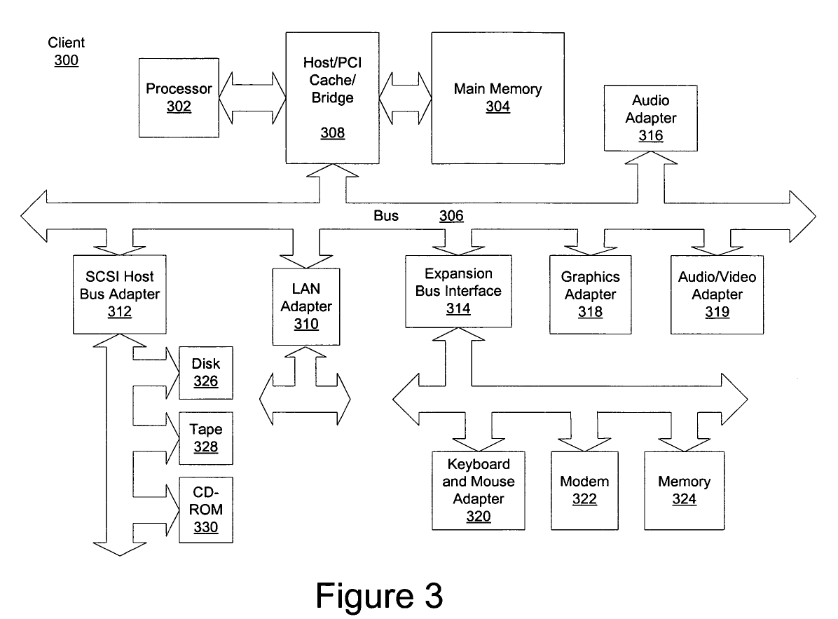

With reference now to FIG. 3, a block diagram of a data processing system in which the present invention may be implemented is illustrated. Data processing system 300 is an example of a client computer. Data processing system 300 employs a peripheral component interconnect (PCI) local bus architecture. Although the depicted example employs a PCI bus, other bus architectures, such as Micro Channel and ISA, may be used. Processor 302 and main memory 304 are connected to PCI local bus 306 through PCI bridge 308. PCI bridge 308 may also include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. In the depicted example, SCSI host bus adapter 312 provides a connection for hard disk drive 326, tape drive 328, CD-ROM drive 330, and digital video disc read only memory drive (DVD-ROM) 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation of Redmond, Wash. “Windows XP” is a trademark of Microsoft Corporation. An object oriented programming system, such as Java, may run in conjunction with the operating system, providing calls to the operating system from Java programs or applications executing on data processing system 300. Instructions for the operating system, the object-oriented operating system, and applications or programs are located on a storage device, such as hard disk drive 326, and may be loaded into main memory 304 for execution by processor 302.

Those of ordinary skill in the art will appreciate that the hardware in FIG. 3 may vary depending on the implementation. For example, other peripheral devices, such as optical disk drives and the like, may be used in addition to or in place of the hardware depicted in FIG. 3. The depicted example is not meant to imply architectural limitations with respect to the present invention. For example, the processes of the present invention may be applied to multiprocessor data processing systems.

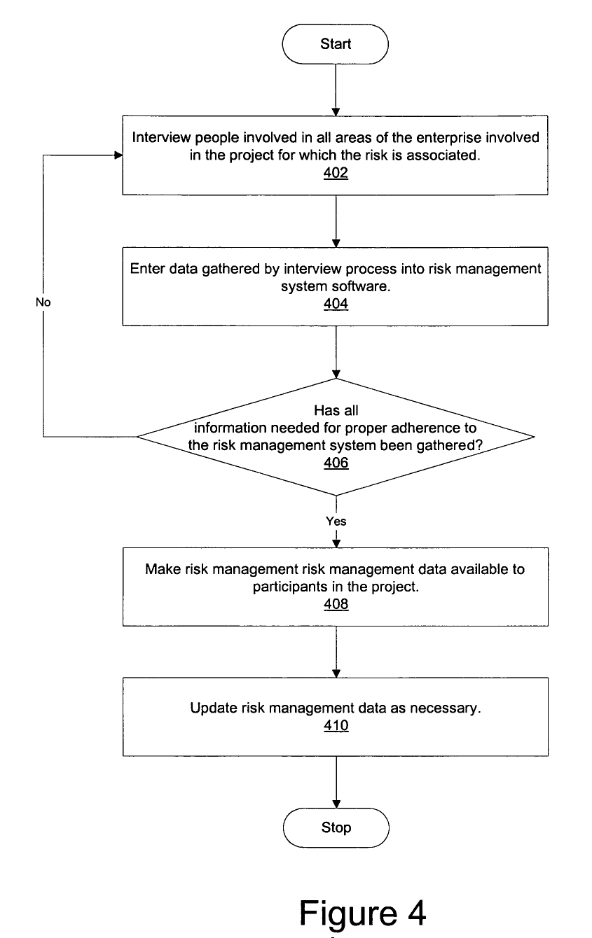

With reference now to FIG. 4, a process flow and program function diagram illustrating a high level view of the risk management system is depicted in accordance with one embodiment of the present invention.

To begin, a person involved in enforcing adherence to a risk management scheme (risk manager) interviews people involved in all areas of the enterprise involved in the project for which the risk is associated (step 402). Thus, information necessary for adherence to the risk management scheme is obtained. Next, this data is entered into the risk management software (step 404). The software, as described below, is configured so as not to allow the risk management person to continue through the software until appropriate information necessary for adherence to the risk management scheme has been entered. Therefore, the software determines whether all information needed for proper adherence to the risk management system has been gathered (step 406). If information has been omitted, then the risk manager interviews appropriate people (step 402) if necessary to obtain the missing information and enters the missing information into the system (step 404).

If the appropriate and necessary information for adhering to the risk management system has been entered, then the data entered into the system is made available to other participants in the project in the form of, for example, reports and graphs (step 408). However, the other participants are not able to modify the data, but are merely able to access some or all of the data. Updates to the system, identified by participants or by risk managers may be made by risk managers as necessary (step 410).

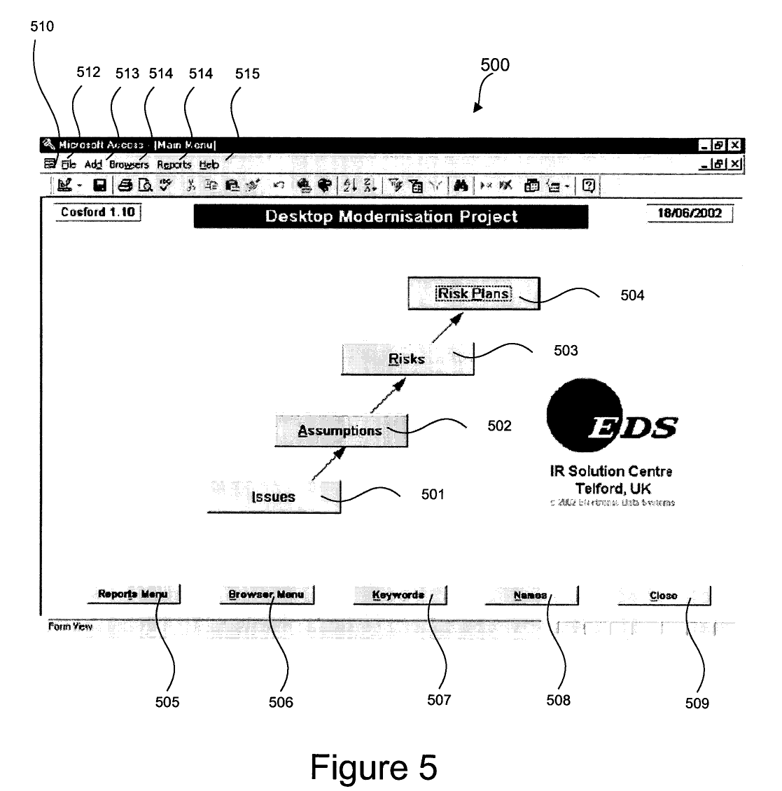

Turning now to FIGS. 5-15, a specific exemplary detailed embodiment of a Risk Management Tool will be described. FIG. 5 depicts an exemplary screen presented to a user upon opening the Risk Management Tool according to one embodiment of the present invention.

On starting the Risk Management Tool, the screen 500 depicted in FIG. 5 is presented to the user. This screen 500 consists of a collection of navigation buttons and is known as the Main Menu. The user is able to return directly to this screen from most other screens in the application. The four main buttons 501-504 in the centre of the screen 500 give direct access to the four entities described in the ABCD methodology: Issues, Assumptions, Risks and Risk Plans. The additional buttons 505-509 at the bottom of the screen 500 offer the user various other features that are explained below.

The Main Menu (and all other screens) can be operated with both the mouse and the keyboard. If one prefers to use the keyboard to operate the buttons, then there are two main methods:

Navigate across the buttons using the Tab key, and then press the Enter key.

Use the Alt key in conjunction with the appropriate underlined letter, e.g. Names 508 can be accessed using Alt+N.

In addition to the navigation buttons the Main Menu 500 also contains a number of dropdown menus available from the menu bar 510 at the top of the screen 500. Clicking on File 511 provides just the single option to Exit the application. The Add menu 512 has two choices: Owner/Action Manager, which is described in more detail below; and Keywords, which is also described in more detail below. The Browsers menu 513 allows immediate access to the Issues, Assumptions, Risks and Risk Plans Browsers, each of which are described in more detail below. The Reports Menu 514 allows immediate access to the following reports:

Risk Review Board Report

Driver Report

Interview List

Summary Reports

Bubble Charts

Sens/Stab Chart

Statistics Report

Reports Menu.

The Help menu 515 offers, among other items, the following: Data Transfer and Registration.

Data Transfer is a facility that is explained in detail below. The Registration window contains the registration details for the database and also allows the user to modify the organization name and register title. It is also possible to replace the supplied logo, if necessary, by pasting in an appropriate graphic image in the box provided.

It is recommended that certain lists be completed before any records have been added to the register as described below. There are two keyword fields available in the Risk Management Tool Risk Register that are used as filters for the reports. It is recommended that Keyword1 be used to identify the reporting level at which the Issue, Assumption or Risk is currently being managed, e.g. “Programme”. Also, each record in the register must be owned by someone. The list of possible names should be set up before any records have been added to the register. The recommended format is First Name followed by Surname.

In normal circumstances the user will want to update an existing Issue record or will want to create a new Issue. Selecting the Issues button 501 on the Main Menu 500 will return a Pop-Up screen allowing the user to select a new issue or update an existing issue. In order to update an existing Issue, enter the Issue Reference Number in an entry box and click on the Find Issue button. In order to create a new Issue record click on the New Issue button. It is also possible to go directly to the Issue Browser screen by clicking.

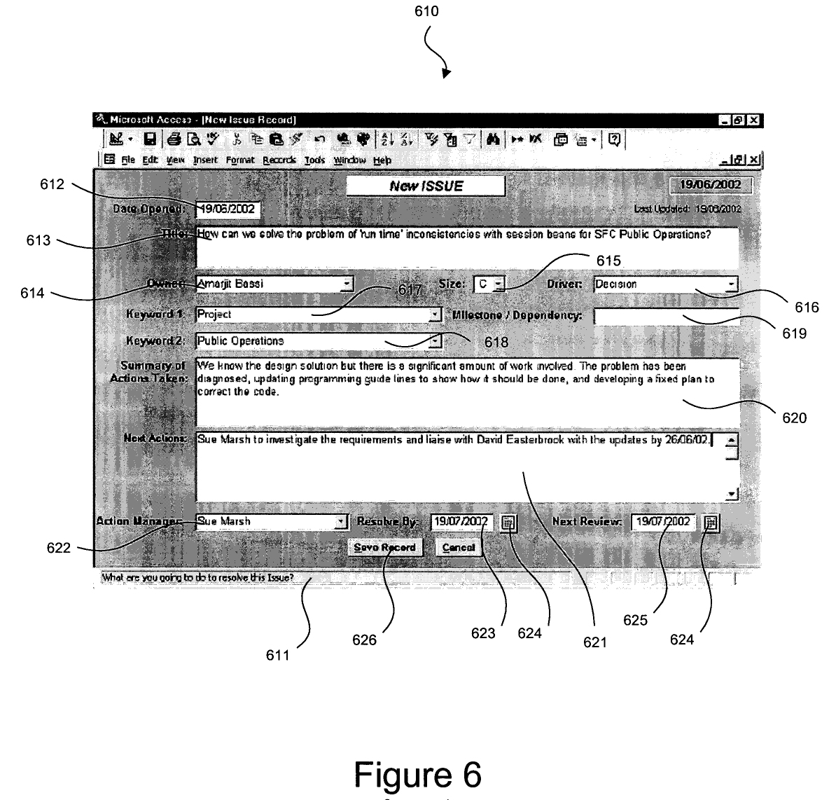

If a new issue is selected, then screen 610 as depicted in FIG. 6 will be returned. Note that the Status Bar 611 at the bottom of the screen 610 contains useful prompts for each field in the screen 610. This applies to all data input screens.

On creating a new Issue record, this date field 612 will be given the current date by default. The date may be amended to an earlier date if necessary. Any date entered in this field 612 will always be displayed in the dd/mm/yyyy format, although it may be entered in a variety of ways. One may, for example include or omit the slash ‘/’ separators. One may enter a two-digit or four-digit year number. If one were to type in ‘1/9/2’ this would be interpreted as ‘01/09/2002’. Note that this applies to all date fields used in the register.

The cursor will be placed initially in the Title field 613. The user should enter the details of the Issue in the form of an open question. The title should normally begin with words such as “How”, “What” or “When”. Note that starting the title with the word “Will” will almost certainly result in a “closed” question!

Every Issue, Assumption, Risk and Risk Plan must be owned by a single person. This owner field 614 is therefore a mandatory field and is completed using the drop-down list of names. If the required name is not included in the list then it may be added by typing the name into the field 614 and then moving on to the next field. If the name is not in the list then a dialog window will appear. Click No in the dialog box if you change your mind and the window will close, returning an error message. Respond to this error message by clicking “OK” and Risk Management Tool will return to the drop-down list. Clicking on “Yes” in the new dialog window will produce a further owner/action manager name dialog window.

The user should enter at least the Name and Department of the Owner on this form in owner/action manager name dialog window. Pressing the Save button will add the new record and return the user to the Issue screen 610. Note that there is a single table containing the list of names and this list is used for both Owners and Action Managers. Once a name has been added to the list, in this embodiment of the Risk Management Too, it cannot be removed, but it may be amended. However, other embodiments may provide for the removal of names.

Returning to FIG. 6, the size field 615, in this embodiment, is mandatory. The user must select A, B, C or D from the drop-down menu. The driver field 616 is also mandatory in this embodiment. The user must select Decision, Milestone, Resource, Technical, Dependency or Business from the drop-down menu.

There are two keywords available for Issues, Assumptions, Risks and Risk Plans. The use of these two fields 617 and 618 is at the discretion of the user's organization. Keyword1, for example, may indicate the reporting level for the Issue and Keyword2 may contain the name of the Project. The keywords may then be used in combination as filters for the production of various management reports.

The Keyword1 and Keyword2 lists will normally be created at the start of a project using screens described in more detail below. However, if a new Keyword needs to be added at this point then the user should enter the new keyword into the field 617 or 618.

Notice that the Risk Management Tool register is supplied with the keyword ‘ALL’ in both Keyword1 and Keyword2. This is included in the list to allow the user to select all possible keywords for a specific report. Although it appears as a default for new records, it should be replaced by a more suitable choice immediately.

The milestone/dependency field 619 is not mandatory. Issues which are open questions normally arise before project plans have been finalized and, in this case, this field would have no meaning. However, where a Risk has impacted and the problem is converted to an Issue, there may well be a milestone to enter in the field 619. If the Driver inserted at field 616 above is “Dependency” then this milestone/dependency field 619 should also include a reference to the name of the particular dependency.

The summary of actions taken field 620 is used to record a summary of all the actions that have been taken to-date. The field 620 is included on both the single Issue report and on the Issue Summary Report. The field 620 is not intended to hold detailed notes of any meetings or discussions. These are held in a separate Notes field as described below. Note that this summary of actions taken field 620 should be updated following each interview.

The next actions field 621 should contain details of the next actions to be taken to resolve the Issue. Leaving this field blank will indicate a distinct lack of management of the issue. For every Issue there is always some action that can be taken. At the very least, the Issue Owner should be able to arrange a meeting with someone who can help. Try to include the following:

WHAT actions are planned?

WHO is going to carry out these actions?

WHEN must the actions start?

WHEN do the actions need to be completed?

Just as every Issue, Assumption, Risk and Risk Plan must have an Owner; it must also have a person who is appointed to take appropriate action. This action manager field 622 is mandatory in this embodiment and should be a different person than the Owner. Operation of the field is identical to the Owner field described above, including adding new names to the list. This action manager field 622 is inescapably linked to the Next Actions field. There may be many actions identified. The Action Manager is the person responsible for the action that is due to be completed first.

The resolve by date field 623 contains the agreed date by which the Issue needs to be resolved. The user can make use of the accompanying calendar button 624. At the end of an interview with the Issue Owner, the risk practitioner should arrange the follow-up interview and select the appropriate date in the next review field 625. Since Issues need to be resolved urgently, this date should never be more than one month after the date of the interview.

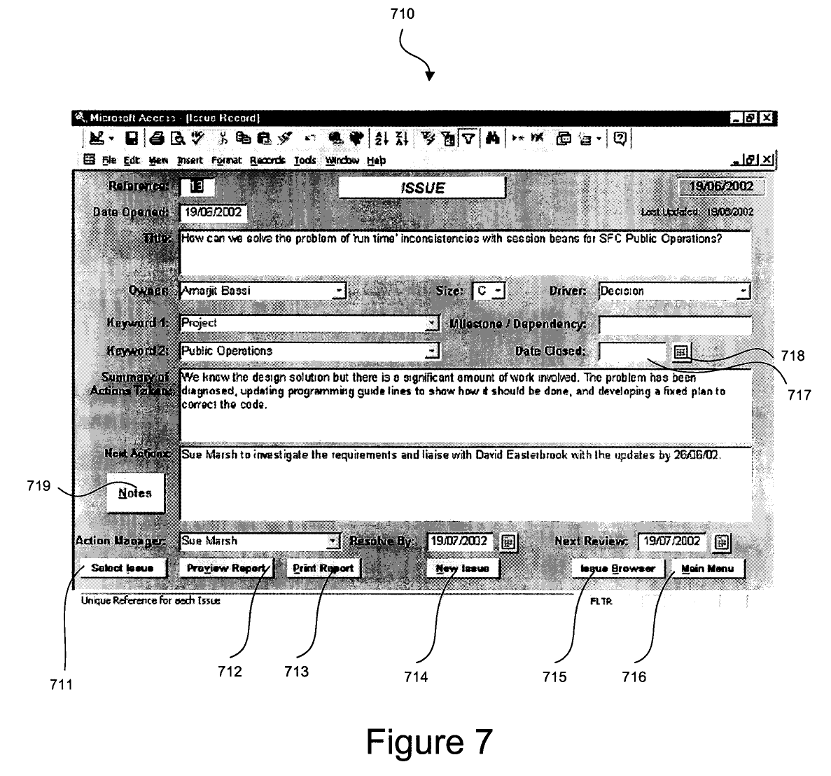

Having entered data into each field 612-625, the user should now save the record by pressing the Save Record button 626. If the data is free from errors, a window indicating this fact will be displayed. This indicates that the record has been successfully saved and shows the Issue Reference Number allocated to it. Clicking on OK on this window will cause a number of extra fields and navigation buttons 711-716 to appear as shown in screen 710 FIG. 7.

The Date Closed field 717 will remain blank while the Issue is live. Once the Issue has been resolved (or converted to an Assumption), the Issue should be closed by entering the appropriate date in this Date Closed field 717. This field 717 is accompanied by a calendar button 718. The actions of the various navigation buttons 711-716 at the foot of the screen 710 is described as follows:

Select Issue 711. Use this button to select another Issue record for viewing/updating. Pressing this button 711 will produce the Add/Update Issue Records pop-up screen as described above.

Preview Report 712. This button 712 will preview the single Issue Interview Sheet. The user may then choose to print the report or not.

Print Report 713. This button 713 prints the single Issue Interview Sheet without giving a preview.

New Issue 714. Press this button 714 to create another new Issue and the “New Issue” screen 610 shown at FIG. 6 will appear.

Issue Browser 715. This button 715 will open up the Issue Browser screen as described below.

Main Menu 716. This button 716 is present in the bottom right-hand corner of most screens and will return the user to the Main Menu 500 as described above with reference to FIG. 5.

Clicking on the Notes Button 719 produces a meeting notes pop-up window. Each Issue can have any number of Notes records for a given Issue record. If there are no associated notes, then a meeting notes pop-up window will appear containing form with a number of fields. Completion of the form provided in the meeting notes pop-up window is as follows:

Date field. The Date field will already be completed with the current date. This field may be amended to the date on which the interview/meeting took place (Shift+Tab to move backwards across the fields).

Person/Meeting. The name of the Issue Owner will be entered automatically in the Person/Meeting field and may be amended, if required. If, for example, the notes were taken from a Risk Review Board then it would be expedient to enter ‘RRB’.

Notes. Enter all the notes taken during the meeting. It is particularly important to record any changes to the data fields in the Issue record and the justification for the change, e.g. “Issue Size changed from C to B following success of first action”. Having entered the data, save the record by clicking on the Save Record button. If an Issue already has associated Notes records, then the latest notes will be displayed when choosing the Notes button. It is possible to view/amend earlier notes by pressing the Earlier Notes button on the Notes pop-up form. One can scroll forward in time by pressing the Later Notes button. Where no further notes are available a suitable message will be displayed and the corresponding button will be grayed out (disabled).

The meeting notes form will remain on screen until the Close Form button is pressed. It is possible to “cut and paste” data from the Notes form into the underlying Issue record using the standard Windows techniques —Ctrl+C (cut) and Ctrl+V (paste) recommended. If changing to a different Issue record, it is possible to leave the meeting notes form visible on screen whilst the change is made. As the change of Issue is made, the meeting notes form will change automatically. Similarly, it is possible to leave the meeting notes form on the screen when running the Print Preview. However, if the user exits the Issue via the Issue Browser or the Main Menu, then the meeting notes form will automatically close.

Each of the data input screens contains at least one field that requires a date to be input. To help ensure that sensible dates are used, most of these fields are accompanied by a small calendar button. Pressing this button will produce a pop-up calendar. Select the date required by using the navigation buttons and double-clicking on the appropriate day. This will update the corresponding date field.

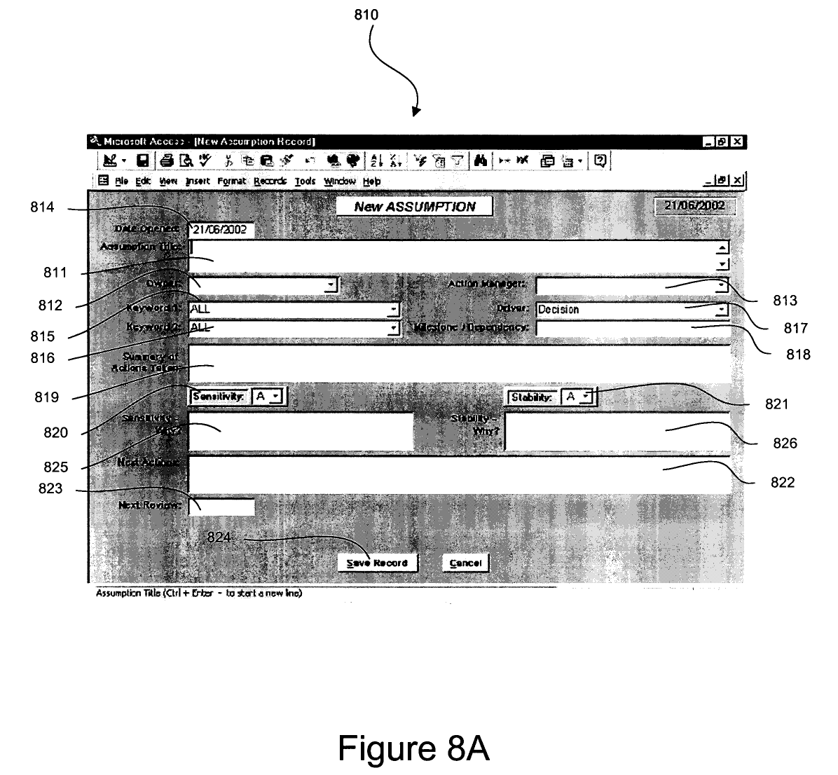

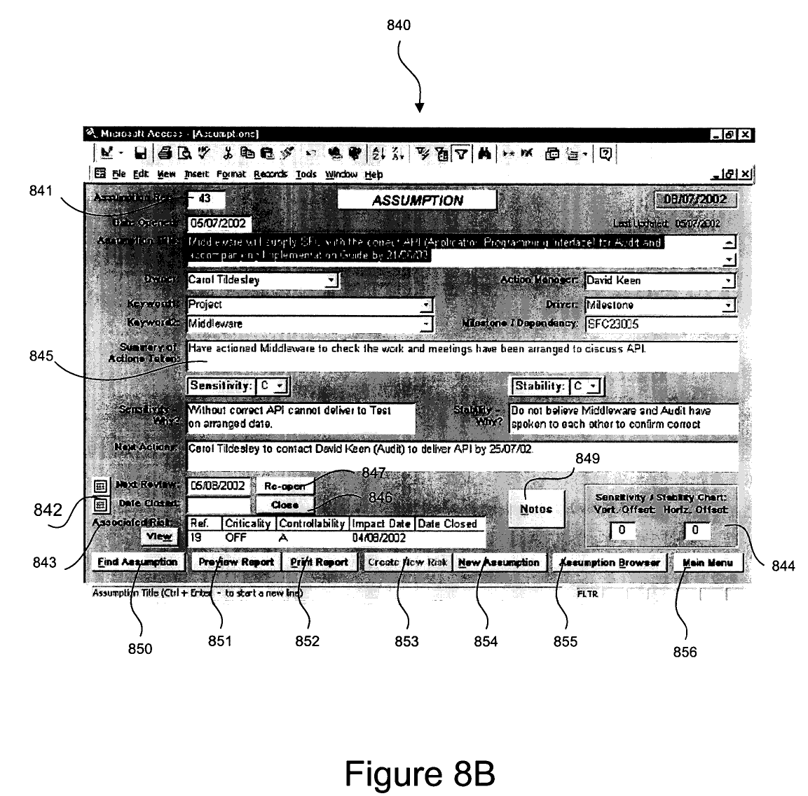

Turning now to FIGS. 8A and 8B, the actions associated with assumptions and the results of selecting the Assumptions button 502 depicted in FIG. 5 will be described. Selecting the Assumptions button 502 on the Main Menu 500 depicted in FIG. 5 will return an add/update assumption records Pop-Up screen. In order to update an existing Assumption, enter the Assumption Reference Number in the ID field and click on the Find button. To create a new Assumption record click on the New Assumption button.

If one has chosen to create a new Assumption, the screen 810 as depicted in FIG. 8A will be returned. The assumption title field 811 is a mandatory field and must be in the form of a “single, simple, positive statement”. It is not necessary to begin the statement with words such as “It is assumed that”—this is implicit in the title. However, Assumption statements will normally include the word “will”. The owner field 812 is mandatory. The action manager 812 is also mandatory in this embodiment. In this embodiment, the date opened field 814 is also mandatory. The default is the current date, but this may be amended to an earlier date. The keywords fields 815 and 816 and the driver field 817 are also mandatory for reasons as explained above with reference to the Issues screens.

The Milestone/Dependency field 818 is not mandatory in the present version of Risk Management Tool. However, since Assumptions are based on project plans, there should be a milestone entered in this field 818 for most Assumptions. Where the Driver 817 is “Dependency” then this field 818 should also include a reference to the name of the particular dependency. The summary of actions taken field 819 is similar to the corresponding field 620 in FIG. 6.

The sensitivity drop down list 820 provides the user with four options from which to choose. These options are as follows:

A Minimal impact if Assumption is incorrect;

B Manageable impact if Assumption is incorrect;

C Significant impact if Assumption is incorrect; and

D Critical impact if Assumption is incorrect.

The Stability drop down list 821 also provides four options from which a user can choose. These options from the drop-down box 821 are as follows:

A—Very confident that Assumption is correct;

B—Fairly confident that Assumption is correct;

C—Uncomfortable that Assumption is correct; and

D—Assumption almost certainly untrue. The sensitivity field 820 is a mandatory field in the present embodiment. The interviewee should always justify the reason for the choice of Sensitivity Rating (A, B, C or D). The Stability field 821 is a mandatory field in the present embodiment. The interviewee should always justify the reason for the choice of Stability Rating (A, B, C or D). The Next Actions field 822 should contain details of any actions to be taken to prevent the Assumption becoming a Risk. Leaving this field 822 blank will indicate a distinct lack of interest in the Assumption. This implies a lack of management and begs the question as to why the Assumption is even on the register. Where actions have been identified, try to include the following:

WHAT actions are planned?

WHO is going to carry out these actions?

WHEN must the actions start?

WHEN do the actions need to be completed?

The field 822 does not need to be updated where there is an associated active Risk record.

At the end of an interview with the Assumption Owner, the Risk Practitioner should arrange the follow-up interview and entered into the next review field 823. Usually this date will be one month after the date of the interview. However, where any actions are scheduled to take place some time in the future then it is sensible to arrange the review accordingly.

Having entered data into each field 811-823, the user should now save the record by pressing the Save Record button 824. If mandatory fields have been left blank then a suitable error message will be displayed. If the data is subsequently free from errors, this will result in a message window indicating that fact and an OK button. This indicates that the record has been successfully saved and shows the Assumption Reference Number allocated to it. Clicking on OK in this message window will cause a number of extra fields and navigation buttons to appear as shown in FIG. 8B.

Referring now to FIG. 8B, the Assumption Reference field 841 shows the number allocated to the new Assumption. The date closed field 842 shows the date the assumption is closed. This field is initially blank. Assumptions should be closed only after any associated Risk record has been closed. Even in situations where a Risk has been closed, it is usual to leave the underlying Assumption open until all possible influencing factors have disappeared. The reasons for closure must be recorded in the Summary of Action Taken field 845 before closing the Assumption. If the date of closure is the current date then the user may just press the “Close” button 846 to the right of the field 842. Note that there is also a “Re-open” button 847, which will remove the Date Closed from the record. Note that a date in this field automatically implies that the Assumption is closed when reports are being produced.

The Associated Risk field 843 will be empty when an Assumption is initially created. However, once a Risk record is raised from the Assumption, then the reference number and other details will appear here. Pressing the View button 848 will present an Update Risk Record window allowing the user to find a risk record by entering a risk ID.

The Vertical/Horizontal Offsets fields 844 control the position of the small Assumption bubble on a Sensitivity/Stability Chart.

Each Assumption record should have its own set of associated Notes records. Pressing the Notes button 849 produces pop-up window allowing a user to enter new notes.

The actions of the various navigation buttons 850-856 at the foot of the Assumption screen 840 are described as follows:

Find Assumption 850. This will produce the same Add/Update Assumption Records pop-up screen as described above.

Preview Report 851. This button 851 will preview the single Assumption Interview Sheet. The user may then choose to print the report or not.

Print Report 852. This button 852 prints the single Assumption Interview Sheet without giving a preview first.

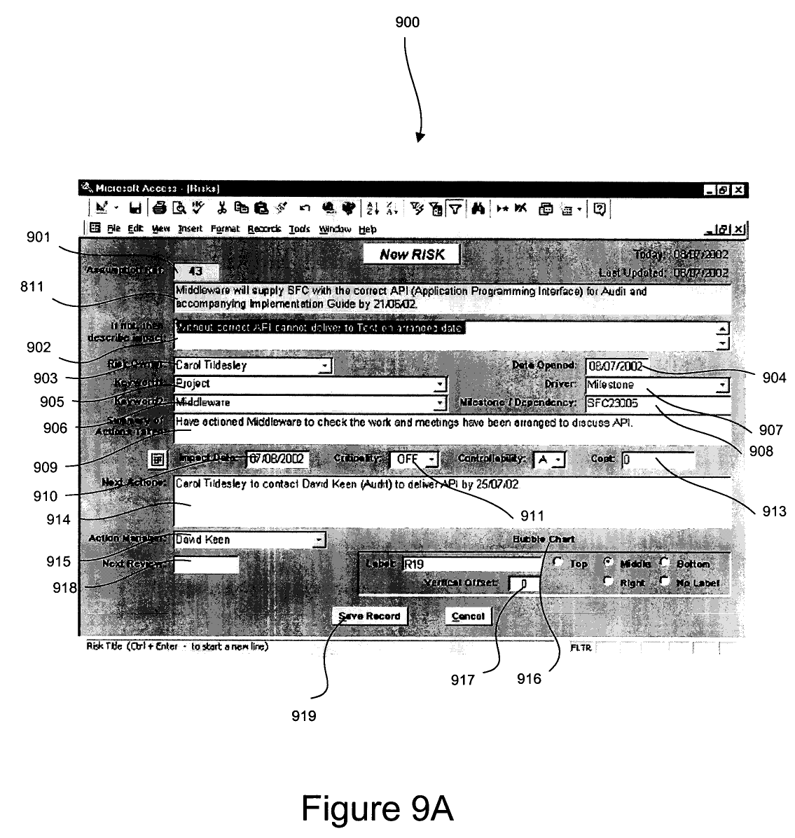

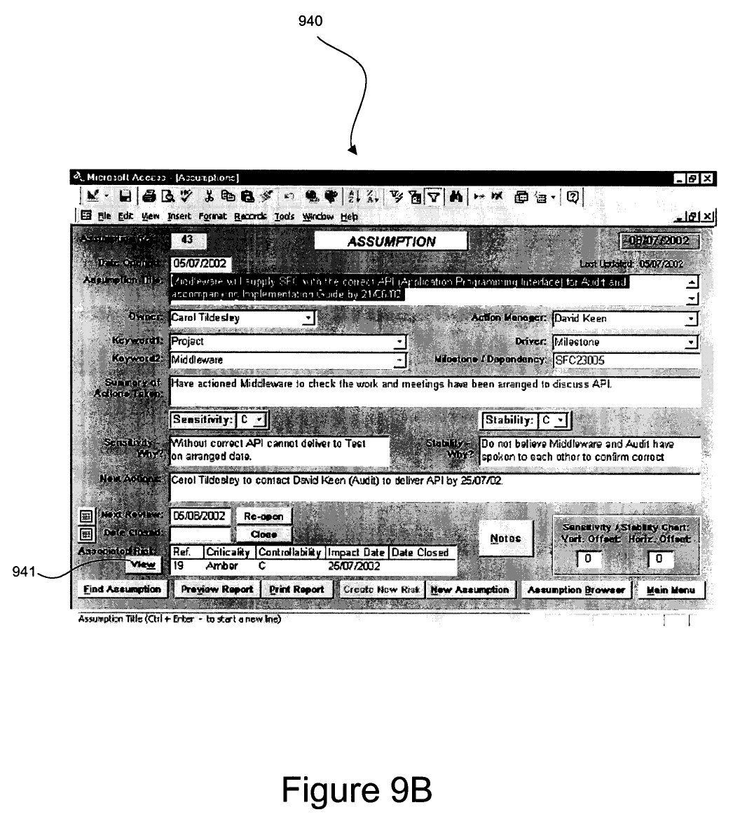

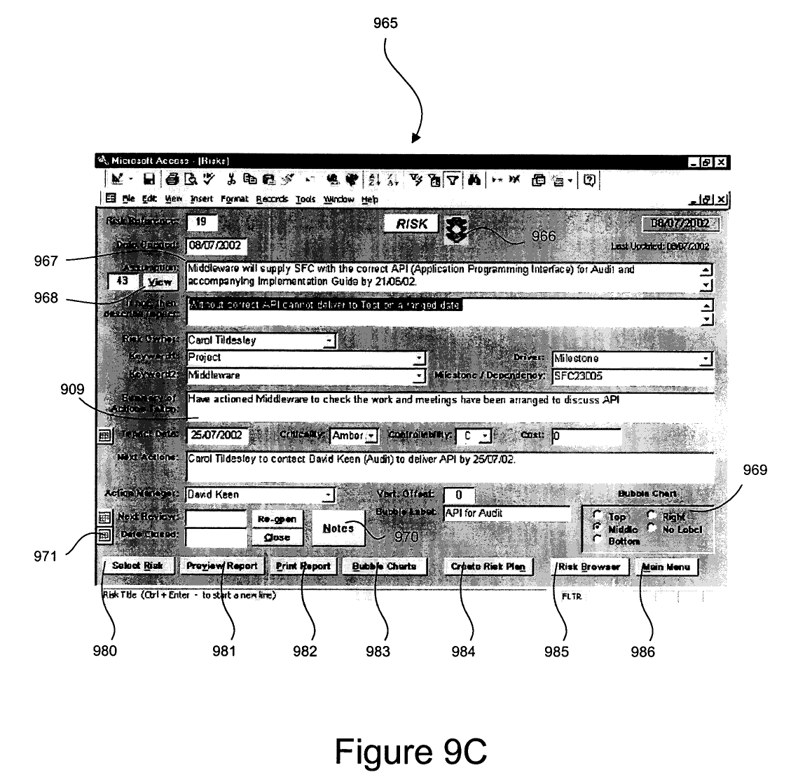

Create New Risk 853. If the Sensitivity/Stability Rating of an Assumption is ‘CC’, ‘CD’, ‘DC’ or ‘DD’, then the user must create an associated Risk record. This button 853 opens a new window for creating a new risk and is described in more detail below with reference to FIG. 9A.

New Assumption 854. This button 854 produces the New Assumption screen as shown in FIG. 8A and described above.

Assumption Browser 855. This button 855 will open up the Assumption Browser screen.

Main Menu 856. This button 856 is present in the bottom right-hand corner of most screens and will return the user to the Main Menu as shown in FIG. 5 and described above.

If the Sensitivity/Stability Rating of an Assumption is ‘CC’, ‘CD’, ‘DC’ or ‘DD’, then the user must create an associated Risk record. The Create New Risk button will return a New Risk screen as shown in FIG. 9A and described below.

Turning now to FIGS. 9A-9C, the actions associated with risks and the results of selecting the Create New Risk button 503 from the Assumption screen depicted in FIG. 8B will be described. Pressing the Create New Risk button 853 on the Assumption screen 840 depicted in FIG. 8B will present a New Risk input screen 900 as shown in FIG. 9A. Notice that most of the fields on this screen 900 have been inherited from the details in the underlying Assumption record. The Assumption Reference field 901 shows the reference number of the underlying Assumption record. The Title field 811 on the Assumption record 810 is shown on this screen 900. It cannot be amended here. If any change to the title is required, then this must be carried out on the Assumption record screen 810.

Since the Assumption title is already visible, it is only necessary to describe the impact if the Assumption fails. This If Not, Then Describe Impact field 902 will be automatically completed with the Why Sensitivity field 825 from the Assumption record 810 to assist with completion. However, note that the impact of a Risk is a top-down view from the Risk Review Board, and not a bottom-up view from the Assumption Owner.

The Risk Owner field 903 will be populated with the name of the Assumption Owner. Since it is likely that the Owner of the Risk is a different person the field will require amending in the same way as described above. The Owner of a Risk must be a member of the Risk Review Board. The Date Opened field 904 will default to the current date. An earlier date may be input, if required. The keyword1 and keyword2 fields 905 and 906 will be the same as the underlying Assumption. It is possible to amend each of these fields 905 and 906 as described above.

The Driver field 907 will be the same as the underlying Assumption. It is possible to amend the field by using the drop-down list. Note that changing this field 907 does not change the equivalent field on the underlying Assumption record. This also applies to Milestone/Dependency field 908. The Milestone/Dependency field 908 will be the same as the underlying Assumption. The Summary of Actions Taken field 909 will inherit the same details as the underlying Assumption, but may be amended, if necessary. Note that the link to the Assumption record is not permanent. The summary should contain enough information to explain to the Risk Review Board how the risk came about and what actions have been taken to-date.

The Impact Date field 910 is a mandatory field that must be a date in the future. The date refers to the last possible start date for action to take place to avoid the impact of the risk. The field should reflect the latest start date of the earliest action identified at next action described below. The Criticality field 911 refers to the traditional Red, Amber, Green impact rating of the Risk. Initially, this field 911 will be supplied by the Assumption Owner, but must be ratified by the Risk Review Board. A guide to the values for a typical project is:

Red: Project stopped or unable to meet key objectives (Showstopper!)

Amber: Project objectives impacted significantly

Green: Project may face minor delays or cost setbacks

It is possible to choose the “OFF” option if the Assumption Owner is not prepared to give a Criticality rating. However, this must be changed to Red, Amber or Green following the Risk Review Meeting. Note that although a record is created within the Risk Management Tool Risk Register, a “Risk” does not technically exist until agreed at the Risk Review Meeting.

The Controllability field 912 describes the degree of control that the Risk Review Board feel they have in managing or preventing the Risk.

A—Very Confident. The management can exercise much control over the Risk. Action plans are in place and are proving successful.

B—Fairly Confident. The Risk is mainly under control. Action plans are in place and in progress.

C—Uncomfortable. The Risk is mainly outside control. There are minimal action plans.

D—Out of Control. There is currently no idea how to manage the Risk, or actions that have been identified have not proved successful. In the latter case, the Risk will almost certainly need to be escalated to a higher authority.

Initially this field 912 will be supplied by the Assumption Owner, but must be ratified at the next Risk Review Meeting. Where the Assumption Owner is not prepared to supply a Controllability rating, then it is usual to use the Stability rating.

The Cost field 913 is optional. Enter the cost of any Risk Action, if required. The Next Actions field 914 should show the action(s) that have been identified to prevent the Risk from occurring. Although this is currently an optional field, it must not be left blank. Leaving this field blank demonstrates a distinct lack of management of the Risk, which begs the question as to why the underlying Assumption has been rated as a Risk. Where actions have been identified, try to include the following:

WHAT actions are planned?

WHO is going to carry out these actions?

WHEN must the actions start?

WHEN do the actions need to be completed?

The latest possible start date for the earliest of the actions must be the same as the Impact Date in Impact Date field 910. The Action Manager field 915 is a mandatory field. The Risk Action Manager must not be the Risk Owner. The Action Manager must be the person named as the Action Manager identified as the person responsible for completing the first of the actions specified in the Next Actions field 914.

The Risk record holds a number of data items relating to the production of the Bubble Charts 916 such as the vertical offset 917. However, it is likely that only the Bubble Label can be completed for a new Risk. It is normal to check on the current position of a Risk bubble before amending any of the offset data. The Next Review field 918 is optional. And similar to that described for Next Review 625 above referring to FIG. 6.

Having entered data into each field 901-918, the user should now save the record by pressing the Save Record button 919. If the data is free from errors, this will result in an ABCD Risk Management Window indicating that the risk was saved the reference number allocated to the risk. Clicking on the OK button in this window will return the original Assumption record as shown in FIG. 9B.

Referring now to FIG. 9B, notice that the screen 940 now contains the main details from the Associated Risk record. One may return to the Risk record by clicking the View button 941.

Selecting the Risks button on the Main Menu will return an Update Risk Record Pop-Up screen. Note that Risks may only be created after first creating an underlying Assumption and then assessing the Sensitivity/Stability Ratings. For this reason, the Update Risk Record pop-up screen allows the user to update an existing Risk but will not allow the user to create a Risk record. As for Issues and Assumptions, there is also the facility to navigate directly to the Risk Browser.

Selecting a Risk record for updating by entering a risk ID into the risk ID field and clicking the find button in the Update Risk Record Pop-up screen will produce screen 965 as depicted in FIG. 9C. Most of the fields on this screen are described with reference to FIG. 9A above. The extra details are as follows:

Traffic Lights 966—The Risk screen shown above has a set of traffic lights 966 at the top to give a quick indication of the criticality status of the Risk. If the Impact Date has passed then an additional red “IMPACTING” message will appear to the right of the traffic lights.

Linked Assumption 967—Having created a Risk record the system automatically records a cross-reference to the underlying Assumption. Every Risk record must have one, and only one, underlying Assumption record. Note that this cross-reference cannot be amended once it has been created. In order to examine the underlying Assumption click on the View button 968 to the left of the Assumption field.

Bubble Label 969—There is a facility on the Bubble Chart reports to include a user-supplied label. Any text entered here should be concise. The Bubble Chart facility allows the user to print the Risk Reference only, the Bubble Label only or both together.

Each Risk record may have its own set of associated Notes records. Pressing the Notes button 970 produces a meeting notes pop-up window. The actions on this window 975 are as the Issue Notes described.

When all Risk Actions have been completed and the Risk Review Board agrees that the Risk may be closed, the date of closure should be entered into Date Closed field 971 as depicted in FIG. 9C. If the current date applies, then the user can press the Close button to the right of the field. In exceptional circumstances where a Risk record has to be re-activated, the user should press the Re-open button to remove the Date Closed field. Closing a Risk will produce a Risk Closed screen.

Referring now to FIG. 9C, the instructions here are quite specific. The user should always record the reason why a risk has been closed in the Summary of Actions Taken field 909. Having done this, the next action must be to re-visit the underlying Assumption record. Depending on the type of action taken with the risk, the user will now reduce either the Sensitivity or the Stability rating to ‘B’ (or possibly ‘A’). The underlying Assumption, which became dormant when the Risk record was created, now becomes active once more. The Assumption record should remain active until the event that it describes has occurred.

The actions of the various navigation buttons 980-986 at the foot of the screen 965 are described as follows:

Select Risk 980—This will produce the update Risk Record pop-up screen as described above.

Preview Report 981—This button 981 will preview a single Risk Interview Sheet. The user may then choose to print the report or not.

Print Report 982—This button 982 prints the single Risk Report without giving a preview.

Bubble Charts 983—This button 983 takes the user directly to the Bubble Chart menu as described below. This is a useful feature when adjusting the position of the bubbles on the chart.

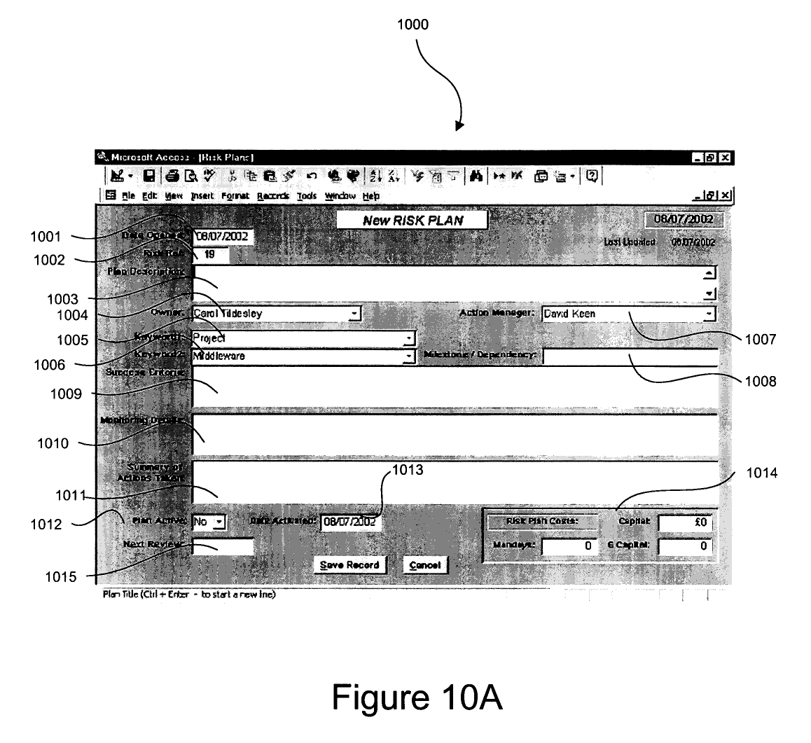

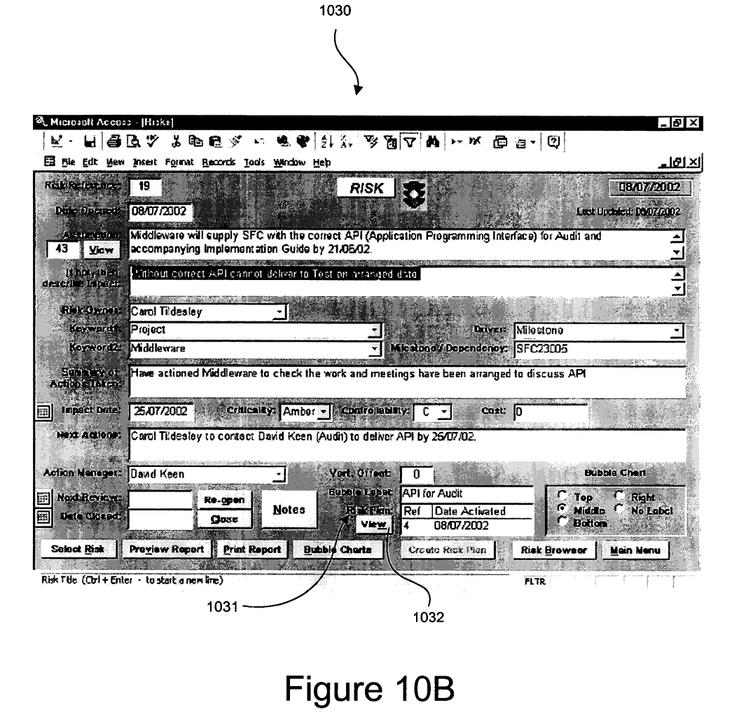

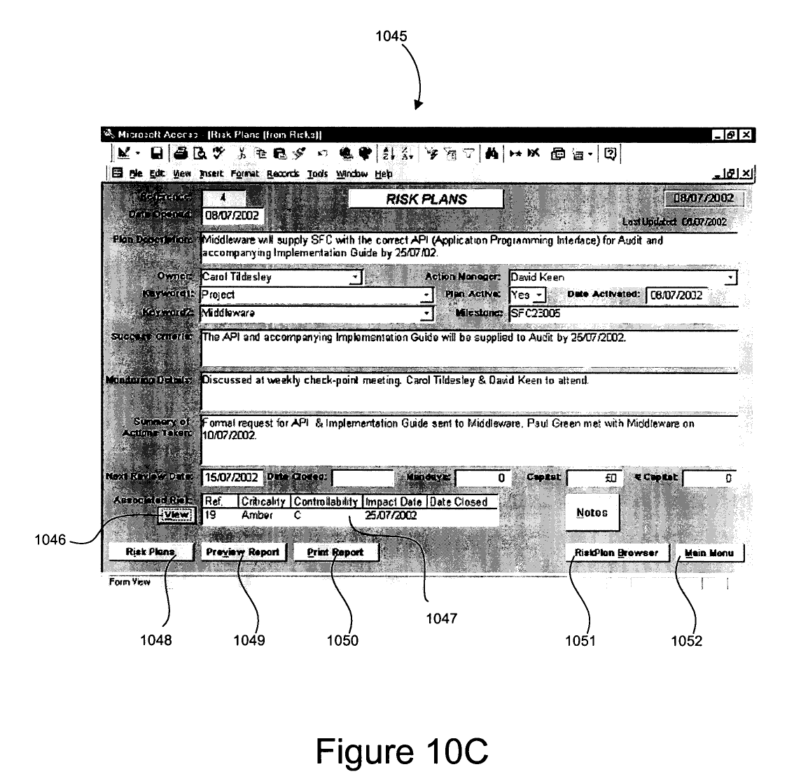

Create Risk Plan 984—The button 984 opens up a New Risk Plan screen 1000 as described below with reference to FIG. 10A.

Risk Browser 985—This button 995 will open up the Risk Browser screen as described below.

Main Menu 986—This button 986 is present in the bottom right-hand corner of most screens and will return the user to the Main Menu as described previously.

Referring now to FIGS. 10A-10C, various screen shots are depicted illustrating development of risk plans utilizing the Risk Management Tool of the present invention. Pressing the Create Risk Plan button 984 on the Risk screen 965 depicted in FIG. 9C will present a blank Risk Plan input screen 1000 as shown in FIG. 10A. The Date Opened field 1001 defaults to the current date, but may be amended to an earlier date. Since the screen 1000 has been invoked from a Risk record, the associated Risk reference number is automatically displayed in the Risk Reference field 1002. The Plan Description field 1003 is the Title field for the Risk Plan. The Owner field 1004 will initially contain the same name as the Risk Owner. If the Owner of the Risk Plan is a different person, then the field 1004 may be amended in the same way as described above.

The Keyword1 and 2 fields 1005-1006 will initially be the same as the underlying Risk. It is possible to amend each of these fields 1005-1006 as described above. The Action Manager field 1007 will be the same as the underlying Risk. It is possible to amend the field 1007 as described above. The Milestone/Dependency field 1008 is optional. A user enters the text to describe how the Risk Owner will judge the success of the Risk Plan in the Success Criteria field 1009. Contingency arrangements and/or fallback plans should be included here. Enter text to describe how the Owner will monitor the progress of the Risk Plan in the Monitoring Details field 1010.

The Summary of Actions Taken field 1011 is the same as described above. The Plan Active field 1012 will default to ‘No’ and is changed to “Yes” when the plan commences. If the Risk Plan is active, enter the date on which it was activated into the Date Activated field 1013. The Risk Plan Costs field 1014 is optional. Details are entered into this field 1014 as appropriate. The Next Review field 1015 is the same as described above and is optional. Having entered data into each field 1001-1015, the user should now save the record by pressing the Save Record button 1016. If the data is free from errors, this will result in a pop-up window indicating that the risk plan has been saved and the reference number allocated to the risk plan. Clicking on OK on this screen will return the user to the Risk record screen 1030 as depicted in FIG. 10B. The Risk screen 1030 depicted in FIG. 10B will now include a reference to the Risk Plan 1031 along with a View button 1032.

Risk Plans must relate to an underlying Risk record. For this reason, the Risk Plans selector pop-up screen 1040 allows the user to update an existing Risk Plan but will not allow the user to create a new Risk Plan record. If the user enters a Risk Plan Reference number in an Update Risk Plan Record pop-up window selector field, then the screen 1045 as depicted in FIG. 10C will be presented. This screen 1045 is similar to the New Risk Plan screen 1000 shown in FIG. 10A and described above with the following additions.

Basic details of the Associated Risk record 1047 are shown at the bottom of the screen. If the full details of the Risk record need to be viewed, then press the View button 1046 to the left of the field 1047. The actions of the various navigation buttons 1048-1052 at the foot of the screen 1045 are described as follows:

Risk Plans 1048—This will produce the same Update Risk Plan Record pop-up screen as described above.

Preview Report 1049—This button 1049 will preview a single Risk Plan Interview Sheet. The user may then choose to print the report or not.

Print Report 1050—This button 1050 prints the single Risk Plan Report without giving a preview.

Risk Plan Browser 1051—This button 1051 will open up the Risk Plan Browser screen as described below.

Main Menu 1052—This button 1052 is present in the bottom right-hand corner of most screens and will return the user to the Main Menu 500 as described above and depicted in FIG. 5.

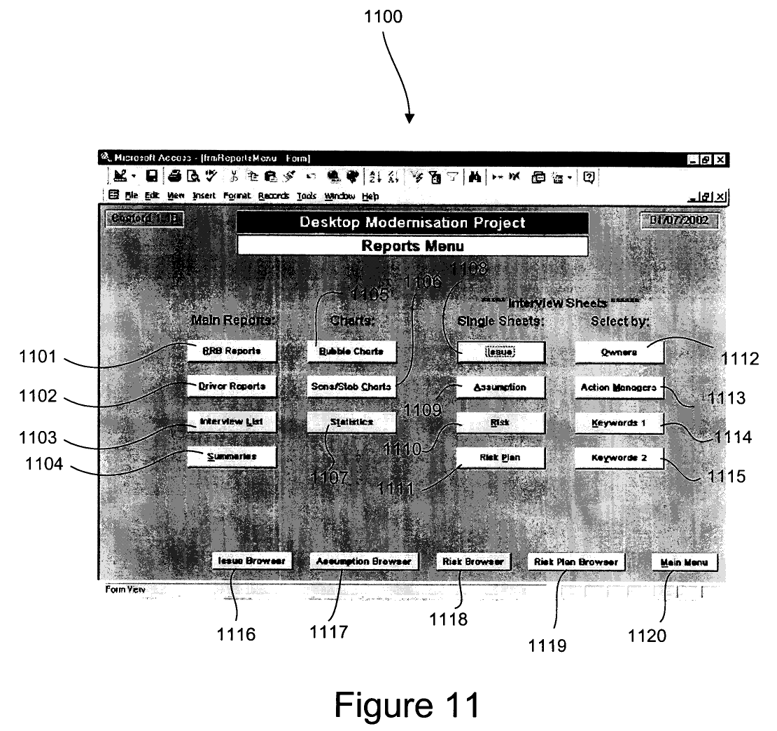

Turning now to FIG. 11, a screen is depicted related to configuring and displaying reports in accordance with one embodiment of the present invention. Pressing the Reports button 505 on the Main Menu 500 will return the Reports Menu screen 1100 as depicted in FIG. 11. A number of different reports are available from the Risk Management Tool Risk Register by clicking one of report buttons 1101 as follows:

RRB Reports—These reports are designed for use by the Risk Review Board at review meetings. They contain all the details held, except the associated Notes records.

Driver Reports—These reports are similar in format to the RRB reports but allow the user to select Risks by Driver.

Interview List—This is a list of all Owners of Issues, Assumptions and Risks designed to assist with scheduling of interviews.

Summaries—These reports are landscape reports summarizing Issues, Assumptions and Risk.

Bubble Charts—Risk Bubble charts are described below.

Sens/Stab Charts—The Sensitivity/Stability Charts are described below.

Statistics—Statistics concerning the active records in the Risk Register are available.

Interview Sheets—These reports show all the details held on the register for any chosen Issue, Assumption, Risk or Risk Plan, including all associated Notes records. The documents are designed expressly for interviewing owners.

Pressing the RRB Reports button 1101 will produce a screen depicting RRB Reports. As stated above, these reports are specifically designed for presentation to the Risk Review Board. The Month and Year fields which appear on this screen will default to the current month/year and are used to produce the Statistics Report which is contained within the RRB Report. The complete report consists of the following:

1. Cover Page.

2. Report List.

3. Statistics Report.

4. Selected Reports. Selected by the user as described below.

Issue Reports

I1. Issues Raised This Month. This report gives details of all new Issues raised during the month selected. All new Issues should be presented in the “reading pack” which is sent to members of the Risk Review Board in preparation for the review meeting.

I2. Issues Closed This Month. As implied by its name this report gives details of all Issues resolved during the month. It is highly likely that many Issues will appear on both report 11 and 12.

I3. Active Issues at Start of Month. In order to complement the view of active Issues, this report includes all those that were already active at the start of the selected month.

I4. All Current Active Issue. This report contains all Issues that are open at the time of the report.

I5. Critical Active Issues. If time is limited in a Risk Review Board meeting, then it may be more appropriate to present this report which will show just those Issues that are rated with Size ‘C’ or ‘D’.

Risks

R1. Risks Raised This Month. Similar to I1 above

R2. Risks Closed This Month. Similar to I2 above.

R3. Active Risks at Start of Month. Similar to I3 above.

R4. All Current Active Risks. Similar to I4 above.

R5. Critical Active Risks. Similar to report I5, this report is intended for Risk Review Meetings with limited time. All Red Criticality risks are “showstopper” and action must be taken on these.

Assumptions

A1. Assumptions Raised This Month. Similar to I1.

A2. Assumptions Closed This Month. Similar to I2.

A3. Active Assumptions at Start of Month. Similar to 13.

A4. All Current Active Assumptions. Similar to I4.

A5. Current Potential Risks. This report shows all currently active Assumptions that are rated as BC, BD, CB or DB. In other words, they are potential risks. This could, of course, include any that were previously rated as risks, where the risk has been closed.

A6. Current “No-Risk” Assumptions. This is a list of all active Assumptions excluding those where there is an active associated risk record.

Driver reports, selected by clicking the Driver Reports button 1102, have been made available to show Risks selected according to Driver. The report has a front cover, followed by the selected Risk records.

The Interview List, selected by clicking the Interview List button 1103, has been designed to assist in the scheduling of interviews. Note that the list only shows the names of interviewees that have currently active records. It is more than likely that there will be other “key players” not shown on the list because they do not have any current active records. These people may have new Assumptions caused by a change in the project plans. Note that there is only a Print Preview option for this report; printing is as for other reports.

Interview Sheets for Issues, Assumptions, Risks and Risk Plans may be selected by Owners, Action Managers, or Keywords. Choosing the Issue button 1108, for example, would return the screen containing a list of issues. In order to choose a record for printing click on the appropriate line in the list. This will highlight the complete line. Pressing the Preview Report command button from this screen will show the Interview Sheet. Double-clicking on the line will have the same effect. This screen gives a preview of a single Interview Sheet prior to printing. The user has the choice at this point to print or not. In order to print the report click on the printer icon on the toolbar or use File, Print . . . and select a specific printer, number of copies, etc. If one does not need to preview the report before printing, then click on the Print Report button and the report will go directly to the printer.

Interview Sheets for Assumptions, Risks and Risk Plans operate in exactly the same manner as described above. Note that the Interview Sheets have been designed specifically for use during a one-to-one interview with the Owner. Changes to details may be written on the sheet, which may then be used as a turnaround document in order to update the Risk Register.

Summary Reports are available for Issues, Assumptions and Risks. Clicking on the Summaries button 1104 will return a Summary Reports screen. As mentioned above, Summary Reports are available for Issues, Assumptions and Risks and in each case, the user may select all records or may restrict the report to open (i.e. active) or closed records. Note that the Assumptions (All) shows all Assumptions, whereas the Assumptions (No Live Risks) excludes Assumptions where there is a live Risk record associated with it. The user may filter these reports by Keyword1 and/or Keyword2. If all records are to be included, regardless of keyword then the user should click on the “ALL” option. The reports show the summarized details from the chosen records and are printed in Reference Number sequence. Printing the report and closing the screen are as per the Interview Sheets described above. Note that the Summary Reports were originally designed for use at the Risk Review Meeting but have now been superseded by the Risk Review Reports.

Pressing the Bubble Charts button 1105 in FIG. 11 will return a Bubble Charts Menu screen. There are three types of Bubble Chart available from this menu: 3 Month, 6 Months and 12 Months. As for the Summary Reports, the user may filter the charts by Keyword1 and/or Keyword2. The user may also elect to print the Risk Reference Number for each bubble, but also has the choice to print the label or both the Risk Reference number and the label. As for other reports, the user can choose to preview the report or print directly. Note that if there are no Risk records to display then a message indicating this fact will be displayed.

It is important to remember that the Bubble Chart is no more than an aid to prioritizing Risks. The diagram cannot be regarded as an accurate diagram when prioritizing the current Risks, since the vertical positioning of the bubbles is under user control as described above. One of the important aspects of the chart is to show Risks that have already impacted and need urgent attention. Impacted Risks are those touching the current date line and to the left of this line. These Risks must be updated as soon as possible by:

(a) completing the Risk Action(s),

(b) converting the Risk to an Issue, or

(c) revising the Impact Date to a later date (this will only happen where further actions have been identified).

Where Risk bubbles overlap to an extent that the diagram becomes confusing, then the bubbles may be moved in the vertical plane by entering an offset in the Risk record. Typical offset values are 3, 6, and 12, but this will require a little experimentation to avoid a bubble moving out of its band (Red, Amber or Green) into an adjacent band. The arcs printed on the chart are included to help decide the priority order when discussing Risk Actions at the Risk Review Board. Allowances should be made for any bubble moved out of the arc due to user-supplied offsets.

The Sens/Stab Charts report, selected by clicking the Sens/Stab Charts button 1106, presents a graph of all active Assumptions by Sensitivity and Stability rating. Clicking on this button 1106 provides a sub-menu. As for other similar sub-menus the user should select appropriate Keyword1/2 choices before pressing the Preview Report button.

Pressing the Statistics button 1107 in FIG. 11 will produce a current statistics screen. The current statistics screen shows various analyses of the data on the Risk Register. The current statistics screen comprises six sections:

Record Counts—This section shows the number of Issues, Assumptions, Risks and Risk Plan records that are currently active (open). The second column of figures examines the Date Opened fields and counts the number of records opened in the month specified at the top of the current statistics screen. The third column examines the Date Closed field. Note that the report will default to the current month. It is possible to amend this by editing the ‘This Month’ and ‘This Year’ fields at the top of the form. In order to display the new figures the user must click on the Refresh button. The only data that will change on the current statistics screen will be the totals in the ‘Opened This Month’ and ‘Closed This Month’ columns.

Active Assumptions—This section analyses the currently active Assumptions by their Sensitivity and Stability ratings. It should reflect the Sens/Stab Chart as described above. The ‘CC’ and above area should also agree with the number of currently active Risks (if it does not, there may be some highly-rated Assumptions that need to be promoted to Risks or, where a risk has recently closed, the Assumption ratings need to be reviewed).

Active Issues—Ideally there should be few, if any, active Issues on the register. Where there are active Issues this section analyses them by age, i.e. >10 means that the Issue was created more than 10 days ago. Since Issues require urgent attention, there should be few outside the 0-30 day range.

Active Risks—The Active Risks section analyses the active Risks by Criticality and Controllability. It is possible to have an active Risk with a criticality shown as “OFF”. This report will serve as a reminder that these Risks need to be clarified as soon as possible.

Risk Impact Dates—This section analyses the number of days until impact for each level of criticality. The top line (<1) represents risks that have already impacted or are impacting today.

Driver Analysis—This section analyses active risk records according to their underlying driver.

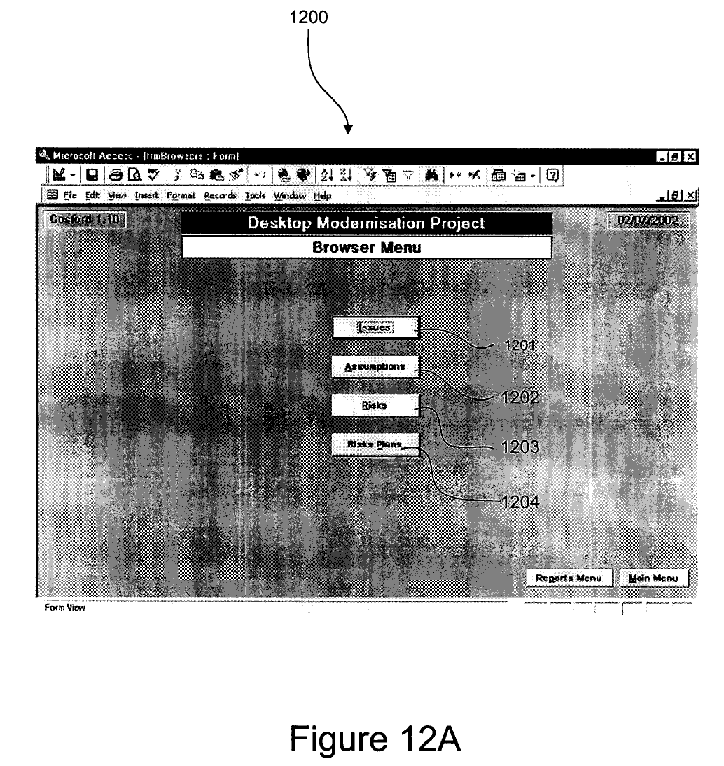

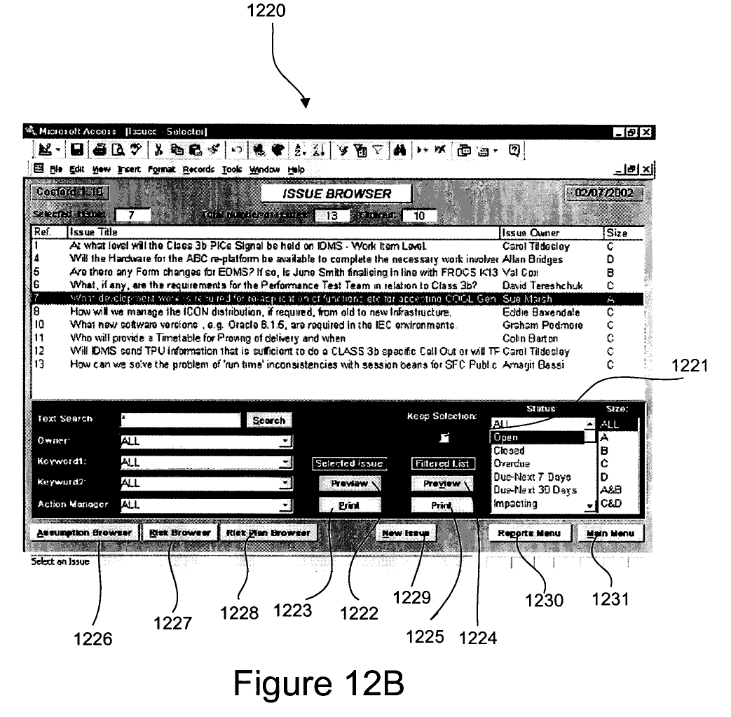

Referring now to FIGS. 12A-12B, screens related to browsers include in the Risk Management Tool are depicted in accordance with one embodiment of the present invention. There are four browsers included in Risk Management Tool to cover, Issues, Assumptions, Risks and Risk Plans. They may be accessed via the four central buttons 501-504 on the Main Menu 500 in FIG. 5 as described above, or they may be accessed via the Browser Menu. Pressing the Browser Menu button 506 on the Main Menu 500 will return the Browser Menu screen 1200 depicted in FIG. 12A. The required browser can then be reached by pressing the appropriate button 1201-1204.

Pressing the Issues button 1201 produces the Issue Browser screen 1220 as depicted in FIG. 12B. The browser screen 1220 is designed to filter the Issues according to a number of criteria. The user may select Issues by Owner, Keyword1, Keyword2, Action Manager, Status, Size or a combination of any/all of them. The result of the filter is a reduced list of Issues. The screen 1220 also allows the user to search for records with a specific item of text in the title field.

If the user wishes to examine in more detail a particular Issue record that is displayed within the current selection, then it is necessary to double-click on the chosen record. This will produce the Issue screen as described above and depicted in FIG. 7.

When the user navigates to another screen, the selection will be lost and the next time that the Issue browser is opened the full selection of (active) Issues will be displayed. In some circumstances it may be useful to retain the selection whilst individual records are being examined. In order to keep the current selection, the “Keep Selection” box 1221 should be checked. If the user wishes to print a selected Issue Interview Sheet, then it is only necessary to highlight the required Issue and press the Selected Issue: Preview 1222 or Print 1223 button. In order to print the complete selection as displayed on the screen, press the Filtered List: Preview 1224 or Print 1225 button, as required.

The actions of the various navigation buttons 1226-1231 at the foot of the screen are as follows:

Assumption Browser 1226—This button 1226 leads directly to the Assumption Browser. Checking the Keep Selection box 1221 will return to the same selection later.

Risk Browser 1227—Similar to the Assumption Browser.

Risk Plan Browser 1228—Similar to the Assumption Browser.

New Issue 1229—Pressing this button 1229 opens the “New Issue” screen shown in FIG. 6.

Reports Menu 1230—This button 1230 will open up the Reports Menu screen as described above and depicted in FIG. 11.

Main Menu 1231—This button 1231 is present in the bottom right-hand corner of most screens and will return the user to the Main Menu 500 as described above.

Selecting the Assumption button 1202 provides the Assumption Browser screen which is similar to the Issue Browser 1220. The Assumption Browser also operates in a similar manner to the Issue Browser 1220.

The Risk Browser screen 1260 has a similar appearance to the Issue Browser 1220. The Risk Browser operates in a similar manner to the Issue Browser 1220, but includes the additional feature of a report selector. The default report for the “Filtered List” Preview and Print Buttons and are the Interview Sheets. The Report drop-down menu also offers the possibility of previewing/printing the 3, 6 or 12 month Bubble Charts. If one of these options is chosen then a Choose Label pop-up screen will appear before the preview/print. This extra choose label screen enables the user to select the type of bubble label prior to producing the chart as described above. The Bubble Chart Menu screen may be reached directly by pressing the Bubble Charts button at the foot of the Risk Browser screen.

Selecting the Risk Plans Browser button 1204 produces the Risk Plans Browser screen. The Risk Plan Browser operates in a similar manner to the Issue Browser 1220.

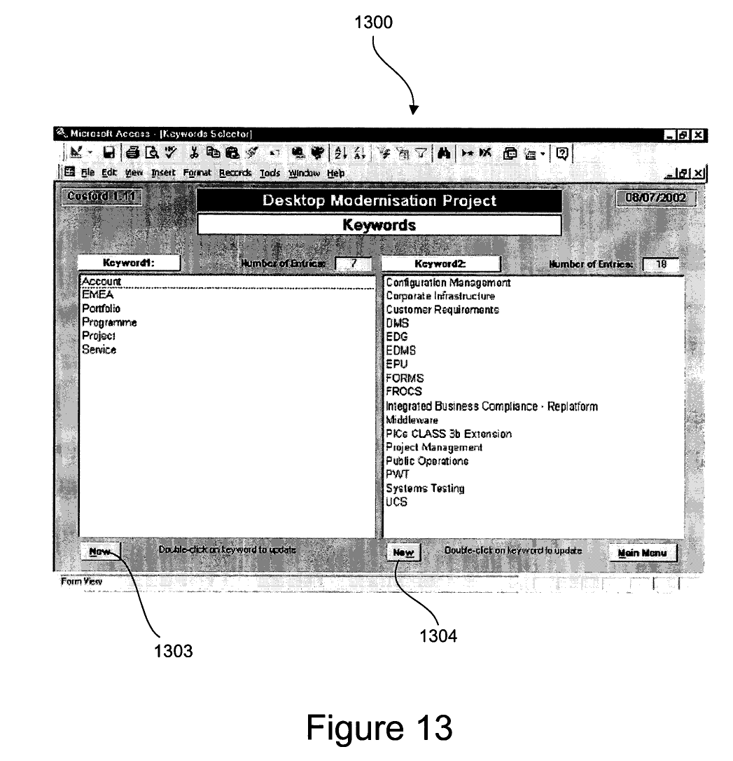

Turning now to FIG. 13, an exemplary screen illustrating adding keywords to the Risk register is depicted in accordance with one embodiment of the present invention. The list of Keyword1s 1301 and Keyword2s 1302 should be built before any records are added to the register. Of course, it will be necessary to maintain these two lists from time to time. Clicking on the Keywords button 507 on the Main Menu 500 depicted in FIG. 5 returns the Keywords screen 1300 depicted in FIG. 13. This screen 1300 will allow further entries to each of the tables by clicking on the appropriate New button 1303 and 1304. To amend an existing record in the table double-click on the selected line and an add/update keyword pop-up screen will be presented. Enter the required keyword and then press the Save Record button. The Risk Management Tool will then return to the main Keywords screen 1300 as depicted in FIG. 13.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for standardizing reporting of issues, assumptions, and risks for a risk review board, the method comprising:
presenting with a form for entering information about a risk management unit;
receiving the information about the risk management unit;
wherein the form provides the user with entry areas for every element needed to properly adhere to a risk management scheme;
wherein the user is hindered from exiting the form prior to supplying all information necessary for adherence to the risk management scheme.

2. The method as recited in claim 1, further comprising:
generating a report in a standardized format based on the information about the risk.

3. The method as recited in claim 1, wherein the risk management unit is one of an assumption, a risk, an issue, and a risk plan.

4. The method as recited in claim 1, wherein the risk management scheme is an ABCD risk management scheme.

5. The method as recited in claim 1, wherein the step of wherein the user is hindered from exiting the form prior to supplying all information necessary for adherence to the risk management scheme comprises preventing the user from exiting an entry field until the user has provided an entry for the entry field.

6. A computer program product in a computer readable media for use in a data processing system for standardizing reporting of issues, assumptions, and risks for a risk review board, the computer program product comprising:
first instructions for presenting with a form for entering information about a risk management unit;
second instructions for receiving the information about the risk management unit;
wherein the form provides the user with entry areas for every element needed to properly adhere to a risk management scheme;
wherein the user is hindered from exiting the form prior to supplying all information necessary for adherence to the risk management scheme.

7. The computer program product as recited in claim 6, further comprising:
third instructions for generating a report in a standardized format based on the information about the risk.

8. The computer program product as recited in claim 6, wherein the risk management unit is one of an assumption, a risk, an issue, and a risk plan.

9. The computer program product as recited in claim 6, wherein the risk management scheme is an ABCD risk management scheme.

10. The computer program product as recited in claim 6, wherein the wherein the user is hindered from exiting the form prior to supplying all information necessary for adherence to the risk management scheme comprises preventing the user from exiting an entry field until the user has provided an entry for the entry field.

11. A system for standardizing reporting of issues, assumptions, and risks for a risk review board, the system comprising:
first means for presenting with a form for entering information about a risk management unit;
second means for receiving the information about the risk management unit;
wherein the form provides the user with entry areas for every element needed to properly adhere to a risk management scheme;
wherein the user is hindered from exiting the form prior to supplying all information necessary for adherence to the risk management scheme.

12. The system as recited in claim 11, further comprising:
third means for generating a report in a standardized format based on the information about the risk.

13. The system as recited in claim 11, wherein the risk management unit is one of an assumption, a risk, an issue, and a risk plan.

14. The system as recited in claim 11, wherein the risk management scheme is an ABCD risk management scheme.

15. The system as recited in claim 11, wherein the wherein the user is hindered from exiting the form prior to supplying all information necessary for adherence to the risk management scheme comprises preventing the user from exiting an entry field until the user has provided an entry for the entry field.
